(19) United States
(12) Patent Application Publication
(10) Pub. No.: US 2025/0004844 A1
(43) Pub. Date: Jan. 2, 2025

(54) SYSTEMS AND METHODS FOR ADAPTIVE BATCHED JOB COMPUTE MANAGEMENT

(71) Applicant: Intel Corporation, Santa Clara, CA (US)

(72) Inventor: Sourav SAHA, Bangalore (IN)

(21) Appl. No.: 18/215,814

(22) Filed: Jun. 28, 2023

(51) Int. Cl. G06F 9/50

(52) U.S. Cl. CPC G06F 9/5038

(57) ABSTRACT

Disclosed are methods and systems for re-allocating compute resources between running EDA jobs. For example, while jobs are running, they may be monitored to select those whose runtimes may be improved by giving them additional memory and/or core resources.

### TECHNICAL FIELD

Embodiments of the invention relate to the field of integrated circuit manufacturing and more specifically, to compute resource management for EDA jobs.

### BRIEF DESCRIPTION OF THE DRAWINGS

FIG. 1 is a diagram illustrating an integrated circuit design flow in accordance with some embodiments.

FIG. 2 is a graph illustrating a relationship between compute resources and potential turn-around-time gain for an EDA job in accordance with some embodiments.

FIG. 3 is a block diagram of a batch-based system for running EDA jobs for a large number of users in accordance with some embodiments.

FIG. 4A is a diagram showing a system for processing EDA jobs in accordance with some embodiments.

FIG. 4B is a flow diagram showing a routine for implementing a dynamic EDA resource allocation scheme in accordance with some embodiments.

FIG. 5 is a flow diagram showing a routine for dynamically updating EDA job resources in accordance with some embodiments.

FIG. 6A is a diagram illustrating how job candidates may be filtered for compute resource upgrade in accordance with some embodiments.

FIG. 6B is a diagram illustrating how filtered job candidates may be ranked and selected for compute resource upgrade in accordance with some embodiments.

FIG. 6C is a conceptual diagram illustrating different job stages for an executing run in accordance with some embodiments.

### DETAILED DESCRIPTION

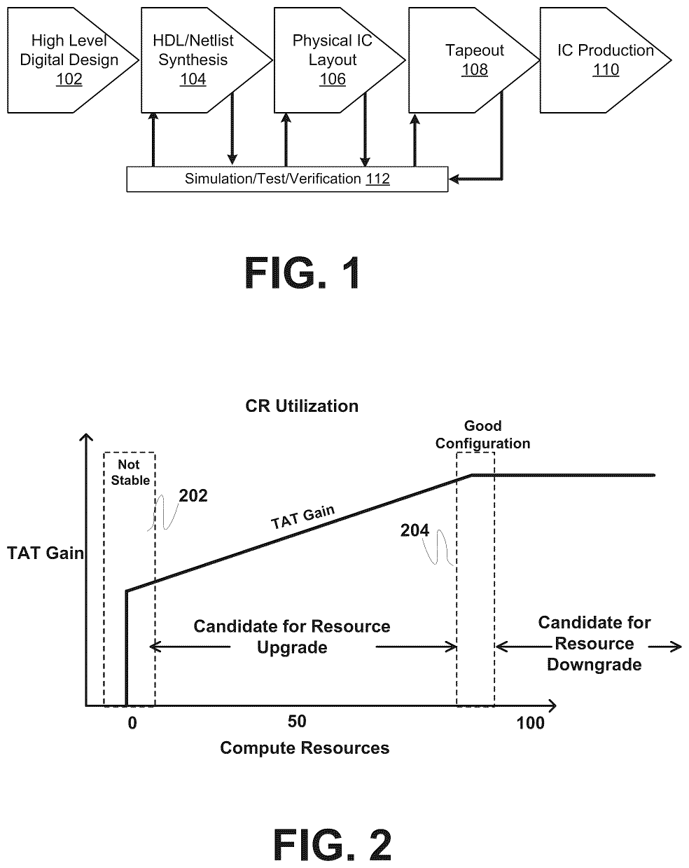

FIG. 1 is a diagram illustrating at a high level an integrated circuit (IC) design flow in accordance with some embodiments. IC design generally begins with a high-level functional design 102. This involves defining functional operations, both at system and sub-system levels. Next at 104 is an HDL (hardware description language) and netlist stage. This involves translating the digital blocks with behavior descriptions developed in the early design phase into an HDL format such as Verilog or VHDL. This phase is often called the Register Transfer level (RTL) phase, which generally includes functional simulation and verification to ensure that the logic implementations meet specification parameters at a high-level. From here, the hardware description is then converted into a gate-level netlist, during which a variety of implementations and optimization routines may be tried to better meet design goals. Important considerations at this stage include power budget, speed, footprint, and reliability.

Next, at 106, physical IC layout typically occurs. Here, gate-level netlists are transformed into physical layouts, which are geometric representations of the layers and physical structures of the integrated circuit. Here, so-called automated placement and routing (APR) tools are typically employed. At 108, the design is ready for tapeout. Verification and simulation are performed, both of which taking into account the placement and physical features of the layout. If successful, the result is an output file, such as GDSII (Graphic Design System II) format, which a foundry can then use to fabricate the IC for the tape-out stage, which includes still more testing and verification to confirm that the IC is operational. Once tapeout test results are satisfactory, the IC can then go into mass production as represented at 110. As is represented at 112, simulation, verification, testing, and re-design occurs along and within each of these design stages.

Throughout these stages, many complex electronic design automation (EDA) tools are used. Chipmakers typically use tools provided by third-party EDA vendors, as well as some that are internally generated, either as stand-alones or as modules integrated with off-the-shelf products, for addressing particular design and manufacturing challenges. For example, some popular EDA tools include Caliber™ tools from Siemens Inc., RedHawk™ tools from Ansys Inc., Fusion Compiller™, VCS™, and Prime Time™ tools from Synopsys Inc., and Allegro™, Innovus™ and Virtuoso™ tools from Cadence Inc., to mention just a few.

Such EDA tools can be both compute and runtime intensive. They can consume numerous processing cores and vasts amount of memory, and they still may take tens if not hundreds of hours for a single job run to complete. (As used herein, a job is the use of an EDA tool as applied to a specific set of parameters to be run on a computing device to perform an EDA function such as modeling, simulation or verification.) Moreover, with modern, complex IC designs, thousands of designers working on various different components and phases of a design may be running EDA Jobs at any given time. Accordingly, vast computing resources are required to meet EDA tool job demands. Even with such resources, it is still important to run the jobs as efficiently as possible, not only to reduce costs, but also, to improve turn-around-time (TAT) in achieving design objectives.

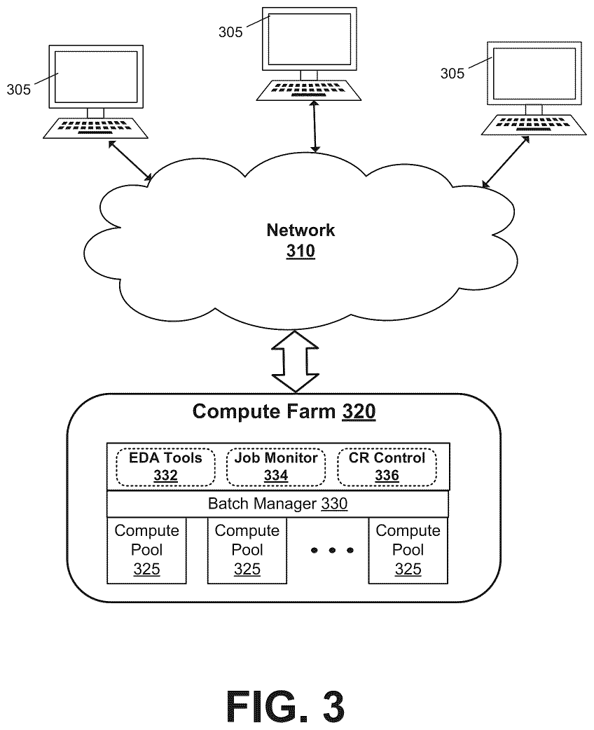

FIG. 2 is a graph illustrating a relationship between compute resources and potential turn-around-time gain for an EDA job. It illustrates TAT gain versus assigned compute resources. If too few resources are provided (as indicated at 202), the job may become unstable, even crashing in some cases. ON the other hand, after a certain point (204), allocating more resources ceases to result in meaningful, if any at all, TAT performance improvements. In this graph, the values indicated along the x-axis (corresponding to increased resources moving rightward) are normalized between 0 and 100 to indicate as a percentile where a job may be in terms of its TAT gain capability. This may be referred to as a TAT gain value. It can be seen that a huge challenge in managing EDA job execution is how to efficiently allocate the available compute resources to the jobs that are to be run at any given time. For example, allocating too many processing cores and/or too much working memory to a job can be wasteful, taking away resources from other jobs that could benefit from the excess resources. ON the other hand, giving a job too few compute resources may be even more problematic in that the job may take excessive time to complete or worse yet crash. Assigning the right amount of compute resources is a complex problem statement that depends on many factors including design state versus deign goals, collateral maturity, and tool configuration, among other things.

Exacerbating this challenge is that with many existing schemes, compute resources assigned to a job may typically not be changed once the job is in flight. Therefore, predictive algorithms using analytics and machine learning (ML) schemes are used to efficiently assign compute resources to jobs before they are dispatched in order to minimize either underloading or overloading. Unfortunately, this can be difficult since conditions may change throughout a job run. In addition, some jobs may not require the same amount of compute resources over an entire run duration. Accordingly, in some embodiments, approaches are provided that allow for job resources to be re-allocated to running jobs, for among other reasons, in order to reduce the average time required to complete an EDA job given a certain amount of available compute resources.

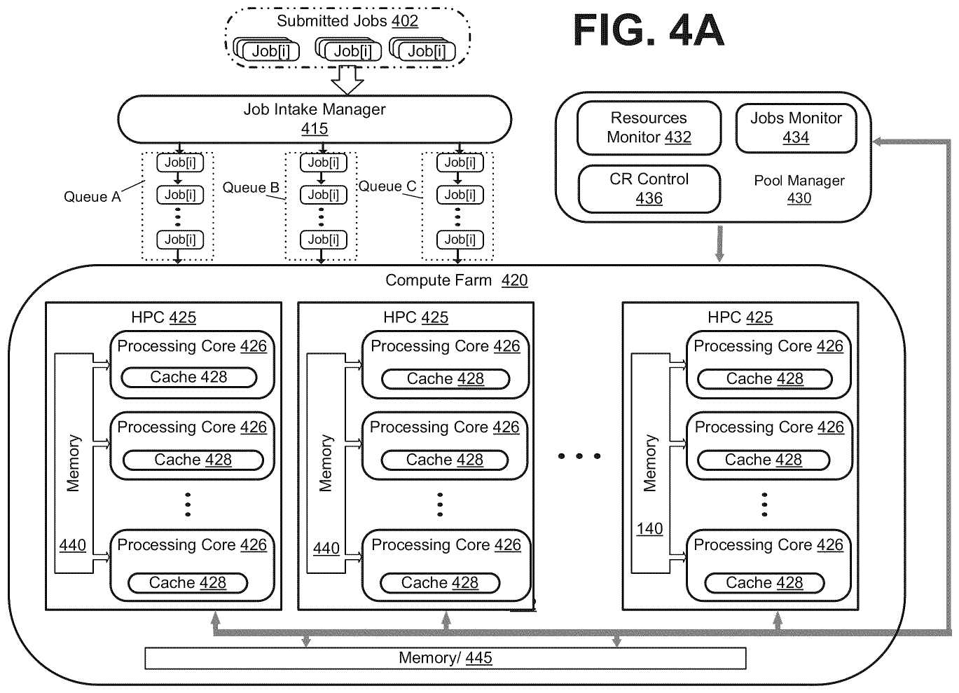

FIG. 3 is a block diagram of a batch-based system for running EDA jobs for a large number of users in accordance with some embodiments. The system includes a plurality of terminal devices (PCs, servers, mobile workstations, etc.) 305 coupled to a compute farm (or compute system) 320 through network 310. Network 310 may comprise one or more local and/or wide area networks configured to provide users with secure, reliable, and efficient access to the compute farm 320. In some embodiments, this system may be used for providing cloud-based services to external users, it may implement a private network for internal design organization users, or it may implement combinations of both private internal and third-party external compute processing services, whether or not provided through cloud-based open or de-coupled restricted network interfaces.

The compute farm 320 includes a plurality of compute pools 325 such as HPC (high performance computer) and/or server pools coupled to one another and to a batch manager interface 330, which may run on any or some of the compute devices or on a device apart from the compute pools. The compute pools each include one or more HPC and/or other computing systems that are configured to run a variety of different EDA tools 332. The compute pools and constituent compute pool devices may be located in a single location or geographically distributed across different physical locations. In some embodiments, the compute pools 325 are designed as a hierarchical system and each may include hundreds or thousands of multi-core machines.

In some embodiments, the batch manager 330 may be implemented with a distributed job batch management engine to among other things, perform job administration and scheduling tasks. To simplify computing operations and make the geography of the physical pools transparent to users, the batch manager 330 may incorporate middleware layers functioning as virtual pool managers. Each virtual pool manager may be configured to connect to one or more physical pools located at the same site or different sites. A virtual pool manager accepts job submissions from users 305, and then distributes jobs to the connected physical pools according to resource availability and batch manager configurations.

The compute farm system also includes a job monitor engine 334 and a compute resource (CR) control engine 336. The job monitor has access to running jobs to monitor various parameters that are used by the CR control engine 336 to adjust compute resources for some of the running jobs in order to improve overall TAT. This will be discussed further in the following sections. It is worth recognizing here, however, that CR re-allocation through the CR control engine may occur across the pools or may be implemented separately within each pool. Different job pools with different job classes, job tool types, etc. may have different sensitivities to CR adjustments and thus, may have to be handled differently within at least some of the separate pools or combinations of pools.

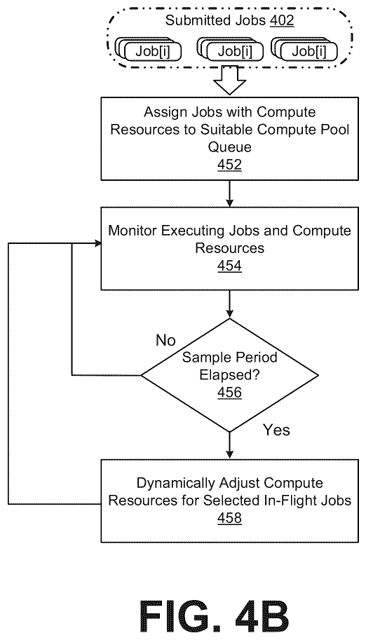

With reference to FIGS. 4A and 4B, a diagram illustrating a system for processing EDA jobs (FIG. 4A) and for implementing a dynamic EDA resource allocation scheme (FIG. 4B) in accordance with some embodiments are shown. The system includes a compute farm 420 having a number of HPC compute systems 425 each including a plurality of processing cores 426. Each HPC compute device 425 has associated shared memory 440, and each processing core 426 has its own local memory 428. The compute farm itself also has associated memory 445, which may be used by some or all of the compute devices 425. Memory 428, 440 and 445 may be implemented with a combination of various different cache levels, system memory (e.g., using dynamic random access memory), and/or non-volatile memory, in shared, distributed, or hybrid architectural configurations.

At 452, jobs 402 are submitted to the compute farm 420 through a job intake manager 415, which may be a part of or work in cooperation with a batch management engine such as 330 from FIG. 3. From there, the jobs may be sent to an appropriate queue (e.g., A, B, or C in this simplified depiction) corresponding to different physical compute pools or different priority statuses. The particularly selected queue may depend, for example, on compute execution needs, priority status, and/or sensitivities to implementing CR re-allocation. That is, with regard to the latter, effectuating resource changes, upgrades and/or downgrades, may be done differently in different job sets. For example, in some sets, they may be staggered, over time from re-allocated job to re-allocated job, or, for example, memory and core changes may be implemented in an alternating cadence to avoid system execution instabilities.

In some embodiments, upon being placed in an appropriate queue, a job is assigned compute resources (e.g., number of cores, memory) for initial execution. For example, historical data of compute usage vs tool turnaround time/crashes and the like may be logged for different tools, design types, configurations, etc. Analytics an/or machine learning based solutions may then use this data to define optimal compute resource assignment settings for a given job type and used for CR assignment for new jobs arriving in a queue.

The job intake manager may schedule job initiation out of a queue using any suitable methods such as round-robin or a weighted tier based approach. Once a job arrives at a physical pool, a physical pool manager 430 may dispatch the job to a particular machine based on the job requirements, e.g., OS/memory, resource availability, and job priority.

In some embodiments, the physical pool manager includes a resources monitor 432 that maintains a list of available compute resources. When a new job is assigned to the physical pool, the pool manager searches its list to find a first eligible machine satisfying the job requirements. If all eligible machines are currently not available, the pool manager may suspend a lower priority job and assign the new job to that newly available machine, or it simply may queue the new job to wait for resources to become available. Alternatively, if none of the machines in the list is eligible, the pool manager 430 may return the job to the job intake manager 415, which will try to schedule the job at a next physical pool.

From an overall compute system, or even compute pool, perspective, achieving compute resource efficiency and balanced distribution is extremely challenging. The compute environment is highly dynamic. At a given point in time, certain jobs are in flight while others are in the pipeline waiting for CR availability. As it is not possible to predict demand profiles for upcoming hours/days, it is virtually impossible to achieve efficient CR allocation when relying solely on optimal initial CR assignment. Accordingly, some embodiments disclosed herein provide improved overall compute efficiency, which can be achieved at individual job/task levels as well as at pool and overall compute farm (or system) levels by applying compute resource re-allocation for some jobs while they are running.

Along these lines, the pool manager 430 includes a jobs monitor 434 and a compute resources (CR) control engine 436. Using these modules, along with resources monitor 432, at 454, the executing jobs are monitored, along with available compute resources, as well as those compute resources expected to become available. The executing jobs are monitored to identify jobs for resource upgrades or downgrades, and the resources are monitored so that the CR control engine knows what additional resources it will have to allocate to jobs selected for resource upgrades. The jobs and resources are monitored until the routine at 456 determines that a predefined sample period has elapsed whereupon it proceeds to 458. Here, it effectuates resource upgrade for the selected jobs. It may do this by freezing affected job execution, redefining operational conditions (number of allocated cores and memory) and then restarting job execution. Alternatively, it might set a flag for a job to halt, or freeze, when it reaches an upcoming checkpoint, a break between operational stages having different TAT/CR profiles. It may do this with particular job sensitivities in mind. That is, some pools or job types may be more sensitive to on-the-fly compute resource changes. In these cases, different approaches such as altering memory/core alterations and/or staggering when resources are changed for individual sub-groups of running jobs may be employed. From here, the CR control routine returns back to 404 and continues as discussed. In this way, compute resource assignment can be increased or decreased in a flexible manner.

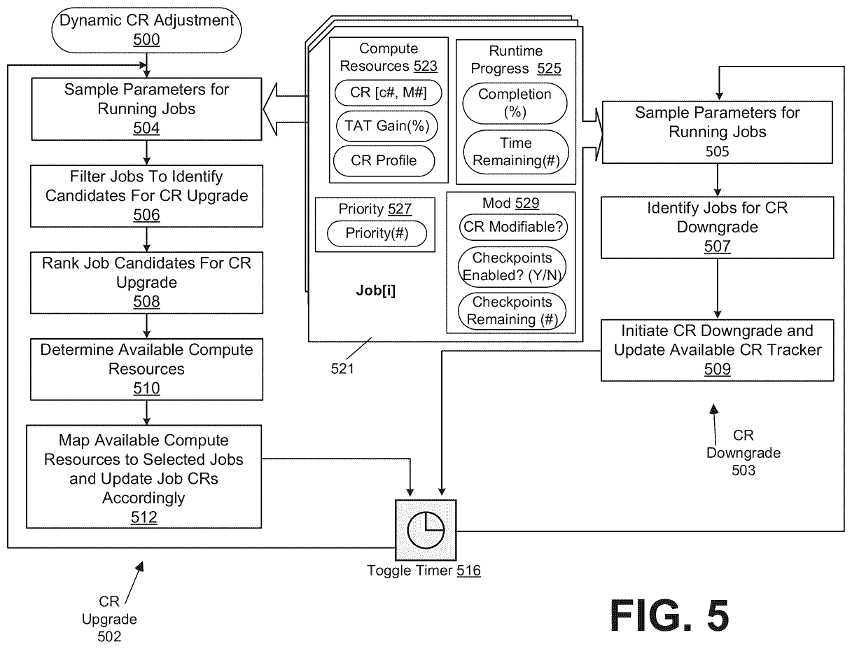

FIG. 5 is a flow diagram showing a routine 500 for dynamically updating EDA job resources in accordance with some embodiments. This routine is divided into two portions, 502 and 503, which alternate in time as indicated through toggle timer 516. Flow portion 502 operates to upgrade CR resources to selected jobs, while flow portion 503 operates to downgrade compute resources from selected jobs in order to free up resources for upgrade candidates that follow.

At 504, the upgrade routine samples parameters from running jobs. For example, it may do this using a job monitor engine 434. As indicated, a job 501 may track and expose to a job monitor several different parameter sets such as compute resource parameters 523, runtime progress parameters 525, priority parameters 527, and/or modification parameters 529.

Compute resource (CR) parameters 523 relate to currently allocated resources, as well as resource utilization and profile data for informing possible resource adjustments. The currently allocated resource data, for example, might indicate the number of cores and amount of memory currently assigned to the job. The TAT gain value corresponds to resource utilization efficiency. It indicates where the job is at, for example, on a TAT gain curve such as the exemplary TAT gain/resource curve of FIG. 2. A TAT gain curve can indicate a job's ability, or inability, to be sped up with added resources. For example, if a job has a score of 95% or higher, it would not benefit much, if at all, from resource upgrade. On the other hand, if it is somewhere along the curve where it is rising, with room to ascend (e.g., a value between 30% and 80%), it may be a good candidate for CR upgrade. The CR profile data corresponds to resource profiles that may be appropriate for the job given its current, or future, conditions and progress in its run. For example, they might convey that TAT improvement for this job will result in a two hour gain for every added core, memory block, etc. up to a certain limit. In some embodiments, profile parameters may be derived from analyzing previous runs or applying ML training schemes to generate ML models to infer desired CR configurations based on a job's running state. They could also convey objective factors such as whether the job is run or could be running as a single or multiple thread execution, whether it could otherwise benefit or even be run on an additional core or cores, and particular memory properties pertaining to whether memory can, or should, be modified.

The runtime progress parameters 525 indicate where a job is in it s current run. These parameters may include a completion percentage and an estimate of the actual time remaining given current resources. Jobs with a significant amount of time remaining may be better candidates for CR upgrade. In some embodiments, the routine may not even consider jobs not meeting a certain minimal remaining time threshold, e.g., 10 hours or more.

The priority parameters 527 relate to a job's relative priority. For example, there may be different priority classes relating to EDA stage deadlines such as imminent tape-out or perhaps some products as a whole, and in turn, their EDA runs as well, are given a top priority status. Priority could also arise from the nature of a job, e.g., whether or not many other jobs depend on its generated results.

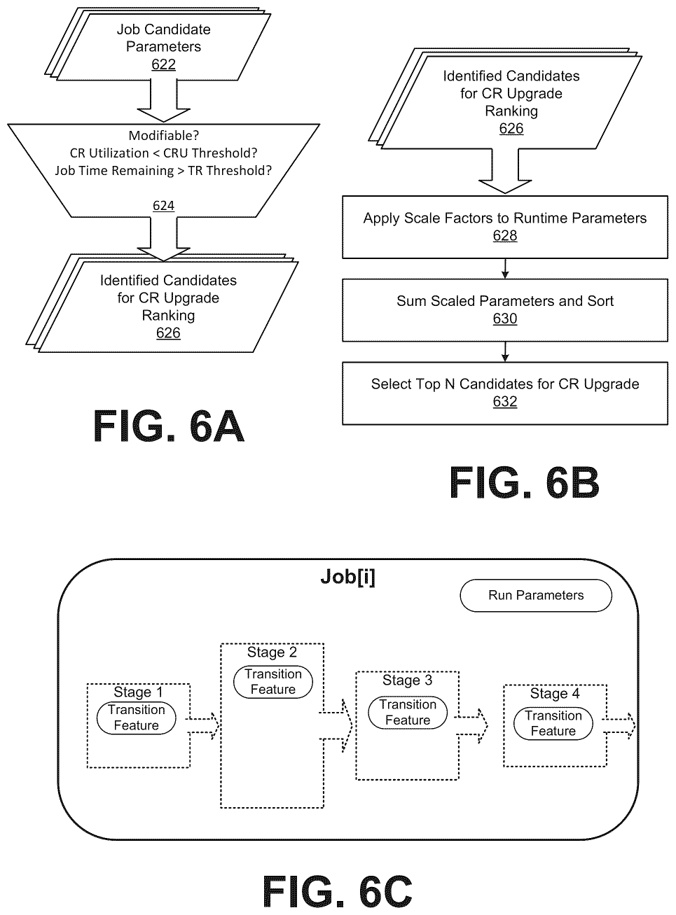

The modification parameters 529 relate to how, if at all, a job may even be interrupted to have its resources changed. These parameters could include Boolean flags such as a modifiable flag and a checkpoint flag. Modifiable pertains to whether or not it can be interrupted and adjusted regardless of the utilized method. Checkpoints pertains to whether it is enabled with checkpoints. Checkpoints are discrete boundaries in a job flow as preconfigured for a given EDA tool. A conceptual example is shown in FIG. 6C, which has four distinct execution stages, each requiring a different amount of compute resources. For example, the wider stages may implement many calculation operations in parallel, which could be sped up with the use of additional cores. In this implementation, each stage also includes a transition feature to indicate to a monitor or CR control engine that (and perhaps when) a next stage is approaching. It may also convey how resources may be changed (e.g., with a freeze/restore operation), or it could initiate the CR upgrade, or downgrade, itself, e.g., by initiating a resource re-allocation procedure supported by the CR control engine.

It has been observed that many tools generate job runs with somewhat natural boundaries where compute resource sensitivity for TAT gain may distinctly transition. In some embodiments, these tools can be modified or made to make use of elastic compute capabilities with transition features, logical internal checkpoints, inserted (FIG. 6C) ahead of the boundaries to facilitate, for example, “freeze” and “restore” operations. Prior knowledge of optimal compute usage for different stages within a tool may also help in altering compute assignment at such marked checkpoints.

The checkpoints remaining parameter indicates how many different compute stages remain in a job's run. This may be important, for example, because even if the job indicates from a runtime progress parameter that it has a lot of time remaining, it may not have any checkpoints left and thus may not be amenable to CR upgrade. On the other hand, even if a small amount of remaining time is indicated, the job may have several checkpoints left, making it worthwhile to upgrade (or downgrade) its compute resources.

Even if a job is not configured with checkpoints and thus would not have the checkpoint flag set, it still might be modifiable. Some jobs could indicate that they can be halted and if the utilization parameter indicates that the job TAT could be meaningfully improved with CR upgrade, then it might make sense to do so. In some embodiments, depending on physical compute configurations and the nature of the job itself, resources may be modified on the fly, without having to halt and restore. This could be done in concert, for example, with power and performance management schemes within one or more specific machines.

Returning back to upgrade flow 502, at 506, jobs are filtered to identify a pool of candidates to consider for CR upgrade. This may not be required in some schemes, but it is recognized that with possibly hundreds of thousands of jobs being run at any given time over a large number of different machines, the challenge of orchestrating CR upgrade becomes much more feasible if many running jobs can initially be eliminated for consideration.

FIG. 6A is a diagram illustrating an approach for filtering jobs. Job parameters 622, e.g., at least some as discussed with reference to 521 in FIG. 5, are applied to threshold filter 624 implemented as part of an executing CR control routine. The filter applies certain parameter thresholds for each running job in a job set. The set may consist of all or a portion of the running jobs in a compute farm. The thresholds may include whether the job is modifiable, whether the TAT gain factor is below a specified threshold value, and whether the estimated remaining runtime is greater than a runtime threshold. It should be appreciated that any combination of these and/or other parameters may be used for a filter in this capacity, and they may be weighted or assessed in different Boolean configurations. For example, some parameters may be “AND'd”, “OR'd”, or evaluated using a combination thereof. For example, in some embodiments, a job will not be considered if it is not modifiable or if it does not have a minimum amount of remaining time or if it has a reasonably high TAT gain value. The jobs 526 that make it out of this filter are then analyzed further for possible CR upgrade

Returning back to FIG. 5 and also looking at FIG. 6B, at 508, the filtered job candidates 626 are ranked to determine which, if any, are to be selected for CR upgrade. FIG. 6B is a flow diagram illustrating a routine for applying a cost function to the job candidates in order to rank them in accordance with some embodiments. At 628, the relevant parameters for a given implementation are normalized and scaled. The parameters are normalized so that they can be combined with each other to attain a cost function value. That is, some parameters may be in absolute units such as hours, minutes, remaining checkpoints, etc., while others may be in percentages such as with TAT gain values. Accordingly, the parameters should be converted into unitless values that are meaningfully relatable against each other. From here, depending on design considerations, some parameters may be of more importance than others and thus, different scale factores for the different parameters may be used to adjust the normalized parameter cost function values.

At 630, once this is done, for each job, the scaled values may be summed together generating an associated cost function score. The job scores can be sorted, and the routine at 632 may then select a set of N top ranked candidates for actual CR upgrade.

Returning to FIG. 5, at 510, the routine determines the amount of available compute resources that can be added to the selected jobs for CR upgrade. This information can be compiled from a resource monitor list, as well as from a list of jobs whose resources are to be downgraded, e.g., pursuant to a CR downgrade flow 503 as will be discussed below.

At 512, the available compute resources are divided and allocated to the N jobs that are being selected for upgrade. In doing this, a variety of approaches may be taken. For example, they could be divided equally and assigned accordingly, taking into account certain exceptions, for example, where a job may not benefit from additional cores or additional memory. Alternatively, a scheme to maximize ROI (return on investment) could be used. Resources could first be allocated to those jobs with the highest available TAT gain, especially in view of their importance as defined, for example, by their priority parameters. In another approach, the N job candidates could be sorted into priority tiers, and a non-uniform rationing of the available resources could be allotted to the various tiers. In other approaches, combinations of these schemes, along with other strategies, could be employed.

The routine then takes action to effectuate the mapped resource upgrade allocations. Any suitable approach may be used, although it should be noted that many tools typically cannot instantaneously react to a freeze command but can stop a run at a next logical level where an execution state can be saved with supporting collaterals so that downstream EDA tool sub-stages can start seamlessly when a Restore command is issued. In some embodiments, a modified compute assignment may be passed on at such a checkpoint overriding a previous assignment. Alternatively or in cooperation with this approach, in some cases, it might issue interrupts to core managers in order to re-assign them, along possibly with memory, to the upgraded jobs. Such interrupts could, for example, be coalesced to occur in sufficient synchronicity with periodic intervals or other events so that overall processing disruption is kept to a reasonable minimum. In some embodiments, the routine could use existing or special queues for assigning jobs with upgraded resources. ‘For example, upon a freeze or halt event, the job could be placed in a special queue devised for purposes of dynamic CR re-allocation. Such queues may act as express queues, having better determinism and faster job initiation response times. They could also be used, for example, as buffers to stagger resource changes for the selected jobs to avoid transition spikes, or surges, and thereby maintain execution stability reducing the likelihood of crashes occurring. In other implementations, flags may be set, such as for jobs with checkpoints, so that they automatically request a halt, or a freeze, prior to entering a next stage and are re-assigned the additional resources that the CR control engine has already allocated to them before the next stage execution begins. Any suitable combination of these, and other approaches, may be employed.

From here, the upgrade routine 502 proceeds to toggle timer 516, which waits for a predefined sample period to end. This sample period may be defined so that there is enough resolution to achieve reasonable TAT improvement but at the same time, is large enough to avoid system instability. For example, a sample period of 15 minutes, 1 hour or several hours could be employed. The toggle timer is a logical representation of a way for the upgrade/downgrade routines to alternate between each other along a cadence that is consistent with a desired sample period. Of course, any suitable way to implement this may be used, and while the period is applied equally for both routines in this embodiment, different periods could be used for either routine, and they may or may not be operated synchronously with one another.

The CR downgrade routine 503 operates similarly to the upgrade routine, and thus, for convenience, the various actions will not be addressed with as much detail. At 505, the parameters for the running jobs are sampled. From here, at 507, candidate jobs are identified for downgrade. As with upgrade, a subset of candidates may be derived from an initial filtering operation. For example, the routine could initially grab only those jobs with a TAT gain value above 95%, indicating that resource downgrade would not meaningfully impact TAT. The routine could apply normalization and scaling, as with upgrade, and identify a set of jobs for downgrade re-allocation. One difference from upgrade, though, is that instead of ranking the candidates and selecting a set number of top-ranked jobs, it might simply select any job that satisfies certain TAT gain criteria such that it would not be adversely affected with a reduction in compute resources. Of course, other parameters such as priority and remaining runtime could also be considered. Added TAT for some jobs may be tolerated in return for the additional resources that could be made available.

At 509, the routine takes action to downgrade the identified jobs and updates its resource tracker accordingly. from here, it returns to the toggle timer 516, which waits for the current sample period to expire and then initiates a next upgrade routine cycle.

Illustrative examples of the technologies disclosed herein are provided below. An embodiment of the technologies may include any one or more, and any compatible combination of, the examples described below.

Example 1 is a computer readable storage medium that has instructions that when executed perform a method that includes monitoring a plurality of parameters for EDA (electronic design automation) jobs running in a compute system. It also includes selecting some of the jobs for compute resource upgrade based on the monitored parameters, and providing the selected jobs with additional compute resources before they have finished running.

Example 2 includes the subject matter of example 1, and wherein the plurality of parameters include a turn-around-time (TAT) gain parameter.

Example 3 includes the subject matter of any of examples 1-2, and wherein the plurality of parameters include a checkpoint parameter.

Example 4 includes the subject matter of any of examples 1-3, and wherein the plurality of parameters include a runtime progress parameter.

Example 5 includes the subject matter of any of examples 1-4, and wherein the plurality of parameters include a priority parameter.

Example 6 includes the subject matter of any of examples 1-5, and wherein selecting includes filtering jobs based on whether they satisfy a remaining runtime threshold.

Example 7 includes the subject matter of any of examples 1-6, and wherein selecting includes determining if the jobs have a sufficient number of remaining checkpoints.

Example 8 includes the subject matter of any of examples 1-7, and wherein providing the selected jobs with additional compute resources includes downgrading selected other running jobs and re-allocating some of their resources to the jobs selected for resource upgrade.

Example 9 includes the subject matter of any of examples 1-8, and wherein providing the selected jobs with additional compute resources includes issuing a freeze request for some of the selected jobs, upgrading their allocated compute resources, and issuing to them a restore request.

Example 10 is a computer readable storage medium that has instructions that when executed perform a method. The method includes in response to inputs from a user, generating an EDA tool job for execution on a compute system. It also includes dividing the job into sequential stages and providing in the job one or more features to indicate to the compute system transitions between the stages to enable the compute system to re-allocate compute resources for a next stage while the job is running.

Example 11 includes the subject matter of example 10, and wherein the job is configured to expose to the compute system operating parameters to inform the compute system for re-allocating the compute resources.

Example 12 includes the subject matter of any of examples 10-11, and wherein the parameters include core and memory parameters.

Example 13 includes the subject matter of any of examples 10-12, and wherein the features enable the compute system to freeze the job, re-allocate the compute resources and restore the job in running without having to withdraw it from execution.

Example 14 includes the subject matter of any of examples 10-13, and wherein the job is executable using multiple threads on multiple cores.

Example 15 is a computer system that includes at least one computing device having core and memory resources. The memory resources include memory to store instructions that when executed facilitate a compute resource (CR) control engine to monitor parameters from a plurality of jobs running on the core resources and to re-allocate resources from the core and/or the memory to a selected portion of the running jobs based on the monitored parameters.

Example 16 includes the subject matter of example 15, and wherein the at least one computing device is a high performance computer (HPC) pool including a plurality of HPC machines and a batch manager to initiate the running jobs on the HPC pool.

Example 17 includes the subject matter of any of examples 15-16, and wherein the monitored parameters include a turn-around-time (TAT) gain parameter.

Example 18 includes the subject matter of any of examples 15-17, and wherein the monitored parameters include a checkpoint parameter.

Example 19 includes the subject matter of any of examples 15-18, and wherein the monitored parameters include a runtime progress parameter.

Example 20 includes the subject matter of any of examples 15-19, and wherein the monitored parameters include a priority parameter.

Example 21 includes the subject matter of any of examples 15-20, and wherein the selected portion of running jobs is derived from filtering jobs based on whether they satisfy a remaining runtime threshold.

Example 22 includes the subject matter of any of examples 15-21, and wherein the selected portion of running jobs is based on determining if jobs have a sufficient number of remaining checkpoints.

Example 23 includes the subject matter of any of examples 15-22, and wherein the selected portion of running jobs is based on normalizing and scaling the monitored parameters in order to rank them.

Example 24 includes the subject matter of any of examples 15-23, and wherein providing the selected jobs with additional compute resources includes issuing a freeze request for some of the selected portion of jobs, upgrading their allocated compute resources, and issuing to them a restore request.

Example 25 is a computer implemented method that includes providing a cloud-based EDA tool interface to allow users to initiate EDA tool jobs on a batch managed processing system that includes core and memory resources. It also includes running the initiated jobs using the core and memory resources and dynamically re-allocating the core and/or memory resources to the jobs based on monitored job parameters.

Example 26 includes the subject matter of example 25, and further comprising, before they are initially assigned to run on the processing system, dividing at least some of the jobs into sequential stages. providing in the jobs one or more features to indicate to the processing system transitions between the stages to enable the processing system to re-allocate the core and/or memory resources for a next stage while the job is running.

Example 27 includes the subject matter of any of examples 25-26, and wherein the jobs are configured to expose to the processing system job parameters to inform the compute system for re-allocating the core and/or memory resources.

Example 28 includes the subject matter of any of examples 25-27, and wherein the parameters include core and memory parameters currently being used.

Example 29 includes the subject matter of any of examples 25-28, and wherein the features enable the compute system to freeze the jobs, re-allocate the compute resources and restore the job runs without having to withdraw them from execution.

Example 30 includes the subject matter of any of examples 25-29, and wherein the monitored parameters include a turn-around-time (TAT) gain parameter.

Example 31 includes the subject matter of any of examples 25-30, and wherein the monitored parameters include a checkpoint parameter.

Example 32 includes the subject matter of any of examples 25-31, and wherein the monitored parameters include a runtime progress parameter.

Example 33 includes the subject matter of any of examples 25-32, and wherein the monitored parameters include a priority parameter.

Example 34 includes the subject matter of any of examples 25-33, and wherein re-allocating includes filtering jobs based on whether they satisfy a remaining runtime threshold.

Example 35 includes the subject matter of any of examples 25-34, and wherein re-allocating includes determining if the jobs have a sufficient number of remaining checkpoints.

Example 36 includes the subject matter of any of examples 25-35, and wherein re-allocating includes normalizing and scaling the monitored parameters in order to rank them.

Example 37 includes the subject matter of any of examples 25-36, and wherein re-allocating includes issuing a freeze request for some of the selected jobs, upgrading their allocated compute resources, and issuing to them a restore request.

Example 38 includes the subject matter of any of examples 25-37, and wherein the additional resources may come from memory and/or cores freed up from completed job runs and/or from cores and/or memory derived by reducing resources with some selected running jobs.

As used in this specification, the term “embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. Different circuits or modules may share or even consist of common components. for example, A controller circuit may be a circuit to perform a first function and at the same time, the same controller circuit may also be a circuit to perform another function, related or not related to the first function.

The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

A circuit design processed as described herein may be implemented within an IC. In one or more embodiments, the circuit design may be processed by a system to generate a configuration bitstream that may be loaded into an IC to physically implement the circuitry described by the processed circuit design within the IC.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “output” means storing in physical memory elements, e.g., devices, writing to display or other peripheral output device, sending or transmitting to another system, exporting, or the like.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth.

A computer program product may include a computer readable storage medium (or media) having computer readable program instructions thereon for causing a processor to carry out aspects of the inventive arrangements described herein. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object oriented programming language and/or procedural programming languages. Computer readable program instructions may include state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

What is claimed is:

1. A computer readable storage medium having instructions that when executed perform a method comprising:
monitoring a plurality of parameters for EDA (electronic design automation) jobs running in a compute system;
selecting some of the jobs for a compute resource upgrade based on the monitored parameters; and
providing the selected jobs with additional compute resources before they have finished running.

2. The storage medium of claim 1, wherein the plurality of parameters include a turn-around-time (TAT) gain parameter.

3. The storage medium of claim 2, wherein the plurality of parameters include a checkpoint parameter.

4. The storage medium of claim 2, wherein the plurality of parameters include a runtime progress parameter.

5. The storage medium of claim 3, wherein the plurality of parameters include a priority parameter.

6. The storage medium of claim 1, wherein selecting includes filtering jobs based on whether they satisfy a remaining runtime threshold.

7. The storage medium of claim 1, wherein selecting includes determining if the jobs have a sufficient number of remaining checkpoints.

8. The storage medium of claim 1, wherein providing the selected jobs with additional compute resources includes downgrading selected other running jobs and re-allocating some of their resources to the jobs selected for resource upgrade.

9. The storage medium of claim 1, wherein providing the selected jobs with additional compute resources includes issuing a freeze request for some of the selected jobs, upgrading their allocated compute resources, and issuing to them a restore request.

10. A computer readable storage medium, having instructions that when executed perform a method, comprising:
in response to inputs from a user, generating an EDA tool job for execution on a compute system;
dividing the job into sequential stages; and
providing in the job one or more features to indicate to the compute system transitions between the stages to enable the compute system to re-allocate compute resources for a next stage while the job is running.

11. The storage medium of claim 10, wherein the job is configured to expose to the compute system operating parameters to inform the compute system for re-allocating the compute resources.

12. The storage medium of claim 11, wherein the parameters include core and memory parameters.

13. The storage medium of claim 10, wherein the features enable the compute system to freeze the job, re-allocate the compute resources and restore the job in running without having to withdraw it from execution.

14. The storage medium of claim 10, wherein the job is executable using multiple threads on multiple cores.

15. A computer system comprising:
at least one computing device having core and memory resources, the memory resources including memory to store instructions that when executed facilitate a compute resource (CR) control engine to monitor parameters from a plurality of jobs running on the core resources and to re-allocate resources from the core and/or the memory to a selected portion of the running jobs based on the monitored parameters.

16. The computer system of claim 15, wherein the at least one computing device is a high performance computer (HPC) pool including a plurality of HPC machines and a batch manager to initiate the running jobs on the HPC pool.

17. The computer system of claim 15, wherein the monitored parameters include a turn-around-time (TAT) gain parameter.

18. The computer system of claim 17, wherein the monitored parameters include a checkpoint parameter.

19. The computer system of claim 17, wherein the monitored parameters include a runtime progress parameter.

20. The computer system of claim 19, wherein the monitored parameters include a priority parameter.
